(19) United States
(12) Patent Application Publication
(10) Pub. No.: US 2015/0121307 A1
(43) Pub. Date: Apr. 30, 2015

(54) INFORMATION PROCESSING DEVICE, INFORMATION PROCESSING METHOD, AND PROGRAM

(71) Applicant: SONY COPRORATION, Minato-ku (JP)

(72) Inventors: Masanori MIYAHARA, Tokyo (JP); Shinobu KURIYA, Kanagawa (JP); Kazunori ARAKI, Kanagawa (JP)

(73) Assignee: SONY COPRORATION, Minato-ku (JP)

(21) Appl. No.: 14/486,119

(22) Filed: Sep. 15, 2014

(30) Foreign Application Priority Data
Oct. 29, 2013 (JP) 2013-224307

(51) Int. Cl. G06F 3/0482

(52) U.S. Cl. CPC G06F 3/0482
USPC 715/811

(57) ABSTRACT

There is provided an information processing device including a score calculating unit configured to calculate a score indicating a relationship between pieces of content, a layout-information generating unit configured to extract content, which is highly related to content selected by a user from content displayed toward the user, based on the score and to generate layout information defining a layout in which the extracted content is emphasized, and a layout-information output unit configured to output the layout information to a display controller for displaying the content toward the user.

### CROSS REFERENCE TO RELATED APPLICATIONS

This application claims the benefit of Japanese Priority Patent Application JP 2013-224307 filed Oct. 29, 2013, the entire contents of which are incorporated herein by reference.

### BACKGROUND

The present disclosure relates to information processing devices, information processing methods, and programs.

For example, JP 2013-80321A proposes a technology in which, when causing a plurality of pieces of electronically-formed descriptive information to be displayed on a display of a terminal device, these pieces of descriptive information are displayed in a predetermined region defined by layout data.

### SUMMARY

However, in recent years, the widespread use of, for example, social media services is causing the types and the number of displayed content to increase. On the other hand, in the technology proposed in, for example, JP 2013-80321A, there is still room for improvement in terms of, for example, presenting more appropriate content to users.

It is desirable to propose new and improved information processing device, information processing method, and program that can present content to a user in a more appropriate layout when displaying a plurality of pieces of content on a display.

According to an embodiment of the present disclosure, there is provided an information processing device including a score calculating unit configured to calculate a score indicating a relationship between pieces of content, a layout-information generating unit configured to extract content, which is highly related to content selected by a user from content displayed toward the user, based on the score and to generate layout information defining a layout in which the extracted content is emphasized, and a layout-information output unit configured to output the layout information to a display controller for displaying the content toward the user.

According to an embodiment of the present disclosure, there is provided an information processing method including calculating a score indicating a relationship between pieces of content, causing a processor to extract content, which is highly related to content selected by a user from content displayed toward the user, based on the score and to generate layout information defining a layout in which the extracted content is emphasized, and outputting the layout information to a display controller for displaying the content toward the user.

According to an embodiment of the present disclosure, there is provided a program causing a computer to exhibit a function that calculates a score indicating a relationship between pieces of content, a function that extracts content, which is highly related to content selected by a user from content displayed toward the user, based on the score and that generates layout information defining a layout in which the extracted content is emphasized, and a function that outputs the layout information to a display controller for displaying the content toward the user.

According to one or more of embodiments of the present disclosure, content can be displayed to a user in a more appropriate layout when displaying a plurality of pieces of content on a display.

The above-described advantage is not limitative. Any of advantages discussed in this specification or other advantages comprehendible from this specification may be exhibited in addition to the above-described advantage or in place of the above-described advantage.

### BRIEF DESCRIPTION OF THE DRAWINGS

FIG. 1. illustrates the configuration of a system according to an embodiment of the present disclosure;

FIG. 2 is a block diagram schematically illustrating a functional configuration of a server according to an embodiment of the present disclosure;

FIG. 3 is a flowchart illustrating an example of a user action acquisition process according to an embodiment of the present disclosure;

FIG. 4 illustrates an example of an action log according to an embodiment of the present disclosure

FIG. 5 is a flowchart illustrating an example of a process for calculating a relationship-indicating score in accordance with an embodiment of the present disclosure;

FIG. 6 illustrates an example of content data according to an embodiment of the present disclosure;

FIG. 7 illustrates an example of a content-relationship-indicating score according to an embodiment of the present disclosure;

FIG. 8 is a flowchart illustrating an example of a process for calculating a preference-indicating score in accordance with an embodiment of the present disclosure;

FIG. 9 illustrates an example of how a sub score indicating preferences between users is calculated in accordance with an embodiment of the present disclosure;

FIG. 10 illustrates an example of how a user-preference-indicating score is calculated in accordance with an embodiment of the present disclosure;

FIG. 11 is a flowchart illustrating an example of a layout-information generating process at the start of display of an information field, in accordance with an embodiment of the present disclosure;

FIG. 12 is a flowchart illustrating an example of the layout-information generating process when the information field in being displayed, in accordance with an embodiment of the present disclosure;

FIGS. 13A to 13D illustrate a first example of emphasized content display according to an embodiment of the present disclosure;

FIGS. 14A to 14D illustrate a second example of emphasized content display according to an embodiment of the present disclosure; and

FIG. 15 is a block diagram illustrating a hardware configuration example of an information processing device according to an embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repealed explanation of these structural elements is omitted.

The description below will proceed in the following order.

### 1. System Configuration

### 2. Device Configuration

### 3. Acquisition of User Action

### 4. Calculation of Relationship-Indicating Score

### 5. Calculation of Preference-Indicating Score

### 6. Generation of Layout Information

### 7. Emphasized Display

### 8. Hardware Configuration

### 9. Supplement

### 1. System Configuration

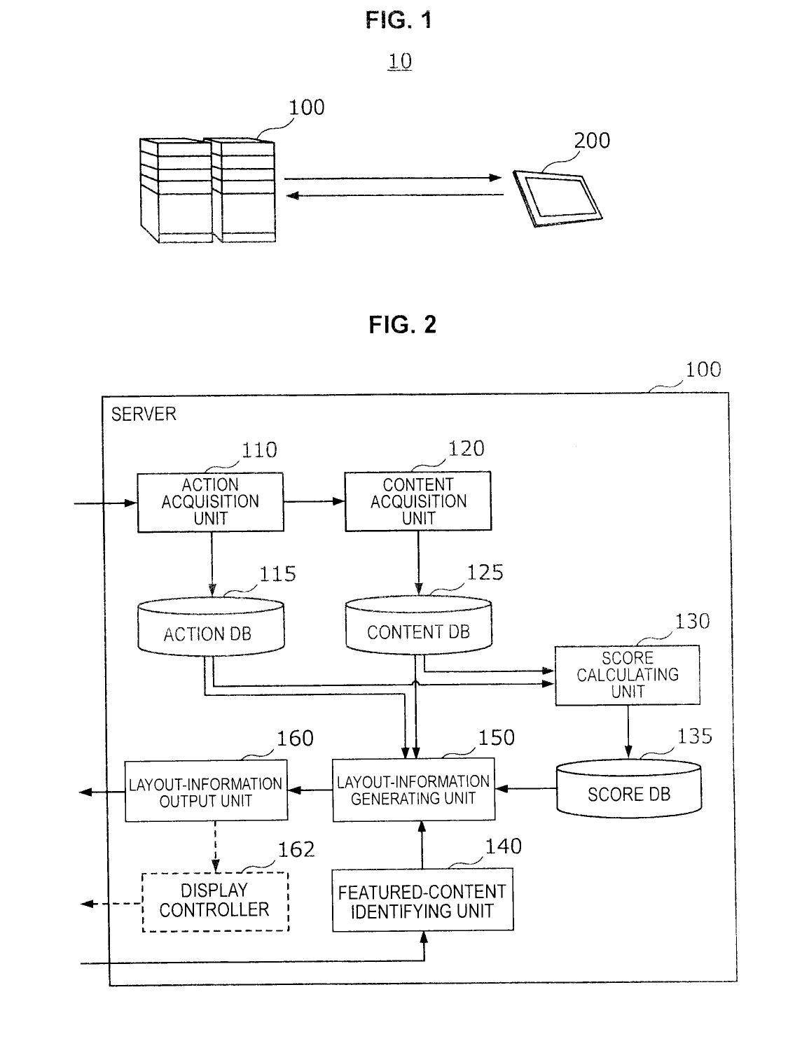

FIG. 1 illustrates the configuration of a system according to an embodiment of the present disclosure. Referring to FIG. 1, a system 10 includes a server 100 and a terminal device (client) 200. The server 100 and the terminal device 200 are connected to each other by a network.

The server 100 is constituted of one or a plurality of server devices. A server device may be realized by a hardware configuration of an information processing device to be described later. The server 100 provides a service to one or a plurality of terminal devices 200. More specifically, the server 100 transmits, to a terminal device 200, information for displaying an information field in accordance with a request received from the terminal device 200. An information field is a screen for presenting, to a user, content of one or a plurality of services by arranging the content in a predetermined layout. The server 100 transmits, to the terminal device 200, the content constituting the information field and layout information defining the layout of the content.

The server 100 may generate the information field by integrating the content provided in a plurality of services used by the user of the terminal device 200. For example, in a social media service, content may include user's action, such as posting a comment or an image or making friends with another user, or information about user's evaluation with respect to an action or an item. For example, in a mail order service, content may include a new item on sale or information about an item recommended to the user based on a buying history. The server 100 may integrate such content provided in a plurality of services in a predetermined order and transmit the integrated content and the layout information to the terminal device 200.

Alternatively, the server 100 may generate the information field based on content provided in a single service (including a service provided by the server 100) used by the user of the terminal device 200. The service may be, for example, the aforementioned social media service or mail order service.

In either example, when generating the information field based on content provided in a certain service, the server 100 may utilize user's action log with respect to content provided in another service. For example, the server 100 may generate layout information for content provided in a first service based on user's action log with respect to content provided in a second service or in the first service and the second service.

The terminal device 200 may be, for example, a tablet terminal, a smartphone, a personal computer of various types, a television, a media player, or a game device. The terminal device 200 may also be realized by the hardware configuration of the information processing device to be described later. The terminal device 200 transmits a request to the server 100 and receives information transmitted by the server 100 in response to the request. The received information may be information for displaying the information field in the terminal device 200. As described above, an information field is a screen for presenting, to the user, content of one or a plurality of services by arranging the content in a predetermined layout. The terminal device 200 receives, from the server 100, for example, the content constituting the information field and the layout information defining the layout of the content. The terminal device 200 displays the information field on a display by arranging the content in accordance with the layout information.

The terminal device 200 has an input device and an output device, which will be described later. The output device includes the display on which the information field is displayed. The input device includes, for example, a touchscreen and/or a keyboard. The user of the terminal device 200 can input various kinds of actions by using the input device. An action may be, for example, an action with respect to the content displayed as the information field, such as input of a comment, an evaluation, or the like on the content, exchanging of messages between users, or friendship-making in a social media service. The information related to the input action may be acquired by the server 100. A more detailed example of the action will be described later.

### 2. Device Configuration

FIG. 2 is a block diagram schematically illustrating a functional configuration of the server according to an embodiment of the present disclosure. Referring to FIG. 2, the server 100 includes an action acquisition unit 110, a content acquisition unit 120, a score calculating unit 130, a featured-content identifying unit 140, a layout-information generating unit 150, and a layout-information output unit 160. A processor in a server device constituting the server 100 operates in accordance with a program stored in a memory or a storage unit so as to realize each of these functional components. The server 100 further includes an action database (DB) 115, a content DB 125, and a score DB 135. These databases may be realized by, for example, the memory or the storage unit in the server device constituting the server 100. These functional components will be further described below.

The action acquisition unit 110 acquires information indicating user's action input to the terminal device 200. For example, the action acquisition unit 110 may acquire any type of action, such as input of a comment, an evaluation, or the like on content displayed as the information field, exchanging of messages between users, or friendship-making in asocial media service. With regard to the acquired action, the action acquisition unit 110 may identify at least one attribute excluding the subject of the action (i.e., the user of the terminal device 200). For example, if an action such as input of a comment, an evaluation, or the like on the content displayed as the information field is acquired, the action acquisition unit 110 identities the type of content of an object (such as posting of a comment or an image by another user or recommendation of an item), as well as the other user related to the content of the object (such as the user who has posted the comment or the image or the user who has recommended the item) or the item (such as the recommended item).

The action DB 115 stores information indicating user's action acquired by the action acquisition unit 110 as a log. As mentioned above, the server 100 provides services to one or a plurality of terminal devices 200. Therefore, the action DB 115 may have an action log of a single user stored therein or an action log of a plurality of users stored therein. The stored action log may be used by the score calculating unit 130, which will be described later.

The content acquisition unit 120 acquires a plurality of pieces of content constituting the information field. For example, the content acquisition unit 120 may acquire content regularly and store the acquired content into the content DB 125. For example, the content acquisition unit 120 may acquire, via a network, content provided in one or a plurality of services provided by a server that is different from the server 100. Alternatively, the content acquisition unit 120 may internally acquire content generated by another functional component (not shown) included in the server 100. The content may include, for example, a comment posted by the user, an item, such as a game, a movie, or music, recommended to the user, or a notification provided to the user from a service provider.

The content DB 125 stores data of the content acquired by the content acquisition unit 120. The content DB 125 may store, for example, actual content or a link to the actual content. Furthermore, the data of the content stored in the content DB 125 may include metadata of the content. The metadata may include, for example, a content ID, a content type, and a time stamp.

The score calculating unit 130 calculates a score of the content based on user's action log stored in the action. DB 115 and the metadata of the content stored in the content DB 125. For example, the score calculating unit 130 calculates a first score indicating the relationship between pieces of content. Furthermore, for example, the score calculating unit 130 may calculate a second score indicating user's preference for the content. The score calculating unit 130 may calculate one of or both of the first score and the second score described above. A specific calculation example for these scores will be described later.

The score calculating unit 130 may calculate the first score and the second score for each user. In other words, for example, the server 100 may store an action log for each user identified based on log-in information input to the terminal device 200 and calculate the first score and the second score with respect to the user.

The score DB 135 stores the scores of the content calculated by the score calculating unit 130. As described above, the scores stored in the score DB 135 may include the first score and the second score. Moreover, the scores may be calculated for each user. For example, the score DB 135 stores the scores in association with the corresponding content ID. In the case of the first score indicating the relationship between pieces of content, the score DB 135 may store the score in association with a plurality of relevant content IDs.

The featured-content identifying unit 140 identities user's featured content in the plurality of pieces of content constituting the information field. For example, of the plurality of pieces of content already displayed as the information field in the terminal device 200, the featured-content identifying unit 140 identifies content selected by the user as the featured content.

The layout-information generating unit 150 generates layout information for displaying the information field based on the content acquired by the content acquisition unit 120 and stored in the content DB 125. For example, the layout information designates the position and the size of a display region for each piece of content on the screen. Several specific examples of the layout will be described later.

In this embodiment, the layout-information generating unit 150 extracts content to be displayed as the information field (i.e., content displayed toward the user) from the content stored in the content DB 125. For example, the layout-information generating unit 150 may acquire user's action log from the action DB 115 and extract content highly related to content appearing in the action log (i.e., content to which any kind of action has already been executed by the user) as the content to be displayed as the information field (i.e., the content displayed toward the user). The relationship between each piece of content and content appearing in the action log is determined based on the first score calculated by the score calculating unit 130.

Alternatively, the layout-information generating unit 150 may extract the content to be displayed as the information field (i.e., the content displayed toward the user) based on the second score, which indicates user's preference for content and is calculated by the score calculating unit 130 based on user's action log. For example, the layout-information generating unit 150 may extract content with high preference as the content to be displayed as the information field.

Furthermore, the layout-information generating unit 150 may extract content highly related to the featured content identified by the featured-content identifying unit 140 (i.e., the content selected by the user) from among the pieces of content to be displayed as the information field and generate layout information defining a layout in which the extracted content is emphasized. The content highly related to the featured content may be identified, for example, based on the first score calculated by the score calculating unit 130 based on user's action log. The featured content may be included or may be not included in the content emphasized in accordance with the layout information.

The layout-information output unit 160 outputs the layout information generated by the layout-information generating unit 150 to a display controller for displaying the information field toward the user. For example, the terminal device 200 has a display controller that causes a display to display the information field toward the user based on information received from the server 100. In this case, the layout-information output unit 160 outputs the layout information together with the content data to the display controller of the terminal device 200. In another example, the display of the terminal device 200 is controlled by a display controller 162 included in the server 100. In this case, the layout-information output unit 160 outputs the layout information together with the content data to the display controller 162.

### 3. Acquisition of User Action

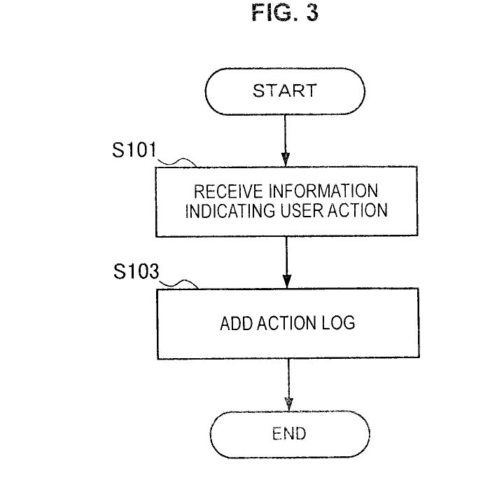

FIG. 3 is a flowchart illustrating an example of a user action acquisition process according to an embodiment of the present disclosure. Referring to FIG. 3, the action acquisition unit 110 first receives information indicating user's action input to the terminal device 200 (S101). The received information may be, for example, a service used by the user or a format that varies depending on the type of action. Subsequently, the action acquisition unit 110 adds an action log to the action DB 115 based on the received information (S103). In this case, the action acquisition unit 110 may generate an action log in a predetermined format based on the received information.

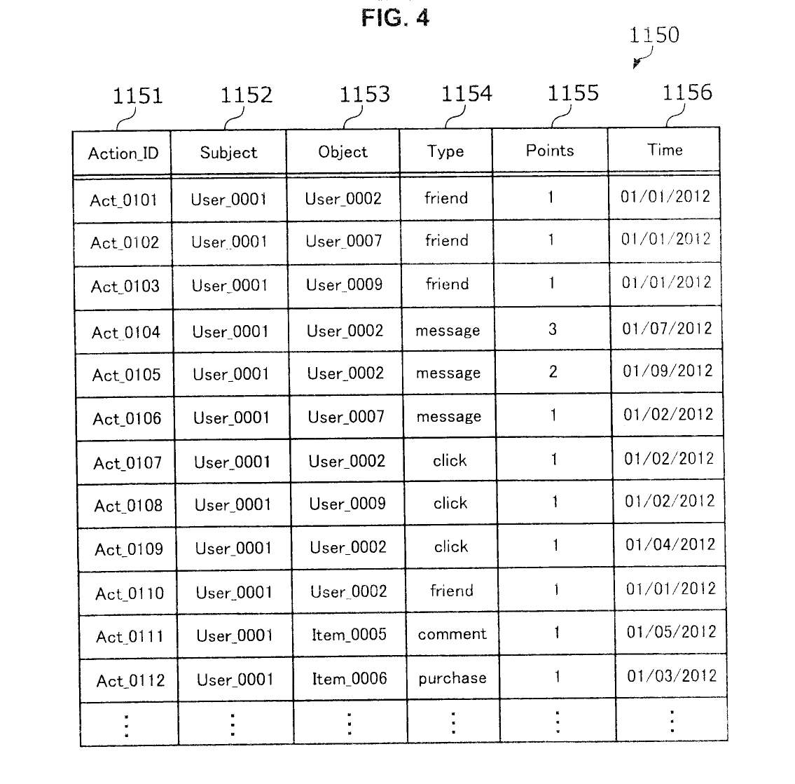

FIG. 4 illustrates an example of an action log according to an embodiment of the present disclosure. Referring to FIG. 4, an action log 1150 stored in the action DB 115 includes an action ID item 1151, a subject item 1152, an object item 1153, an action type item 1154, a point item 1155, and a time stamp item 1156. Although the action log 1150 is shown in a table format for illustrative purposes, the action log 1150 may be recorded in an arbitrary format, such as a text format. The same applies to descriptions of examples of other data.

The subject item 1152 indicates a subject of an action. In the shown example, a user ID (User_{—}0001) of the same user is recorded as the subject item 1152. If action logs of a plurality of users are stored in the action DB 115, it is possible to differentiate between users' action logs based on the user IDs recorded in the subject item 1152. The subject item 1152 is not necessarily limited to a user and may alternatively be, for example, a service provider (system).

The object item 1153 indicates an object of an action. In the shown example, a user ID (such as user_{—}0002) of another user or an item ID (item_{—}0005) is recorded as the object item 1153. As mentioned above, an object of an action may be diverse and may be, for example, another user or an item. Therefore, the object item 1153 may be differentiated based on common IDs as in the shown example, or an item indicating the type of object may be additionally provided.

The action type item 1154 indicates the type of action. In the shown example, recorded types of actions include friendship-making (friend), message transmission (message), clicking on relevant content (click), input of a comment (comment), and purchasing of an item (purchase).

The point item 1155 is used for weighting in accordance with the contents of an action of the same type indicated by the action type item 1154. For example, with regard to message transmission actions (message) indicated by the action type item 1154, points ranging between 1 and 3 are set in the point item 1155 in accordance with the length of the messages. In another example, the points may be a value smaller than 1 or a value larger than 3. In the case where the action type item 1154 indicates friendship-making actions (friend) or clicking-on-relevant-content actions (click), since there is no difference in contents between these actions of the same type indicated by the action type item 1154, 1 point is set in the point item 1155 for all of these actions. In another embodiment, these actions may be given different points in the point item 1155 in accordance with, for example, the times at which these actions occurred.

The time stamp item 1156 indicates the time at which an action occurred. For example, the time at which an action occurred may be reflected on the point item 1155 as described above, or the time stamp item 1156 may be taken into account when the score calculating unit 130 calculates a score. Alternatively, the time stamp item 1156 may be used simply for managing an action log.

### 4. Calculation of Relationship-Indicating Score

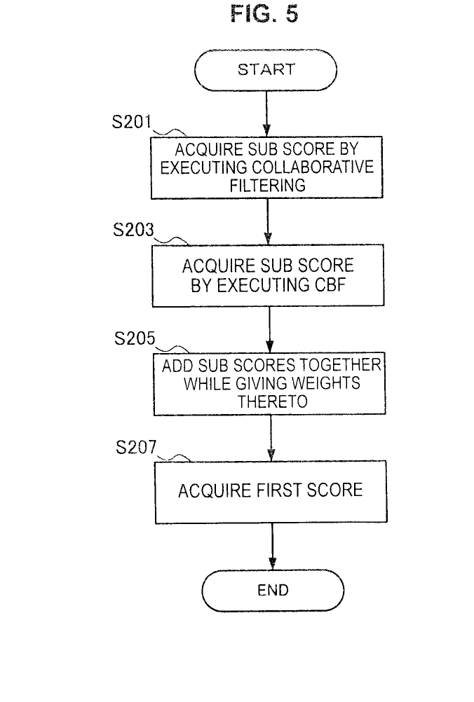

FIG. 5 is a flowchart illustrating an example or a process for calculating a relationship-indicating score in accordance with an embodiment of the present disclosure. Referring to FIG. 5, the score calculating unit 130 first extracts a content-related item from user's action log stored in the action DB 115 and executes collaborative filtering on content (S201). By executing this collaborative filtering, a first sub score indicating the relationship between pieces of content is acquired.

Furthermore, the score calculating unit 130 executes content-based filtering (CBF) by using the metadata of content stored in the content DB 125 (S203). By executing this CBF, a second sub score indicating the relationship between pieces of content is acquired. The score calculating unit 130 adds the calculated first sub score and the calculated second sub score together while giving predetermined weights thereto (S205) so as to acquire a first score indicating the relationship between pieces of content (S207).

With regard to specific techniques for the collaborative filtering and the CBF, since various known techniques can be used, detailed descriptions thereof will be omitted.

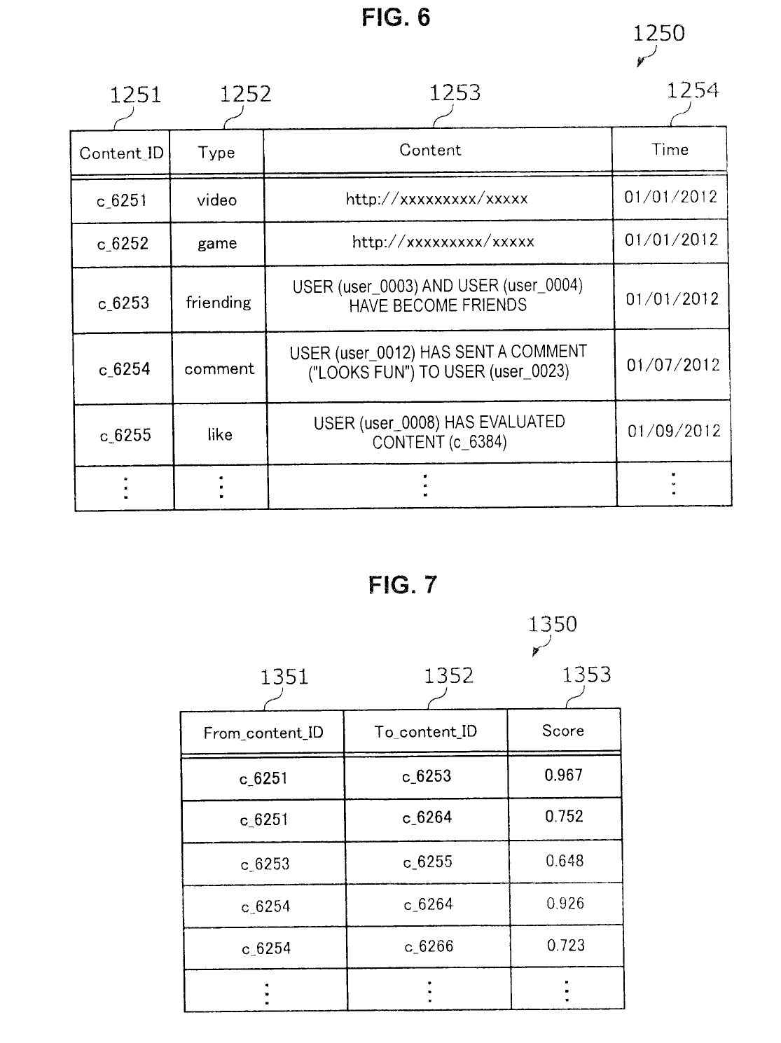

FIG. 6 illustrates an example of content data according to an embodiment of the present disclosure. Referring to FIG. 6, content data 1250 stored in the content DB 125 includes a content ID item 1251, a content type item 1252, a content item 1253, and a time stamp item 1254.

The content type item 1252 indicates the type of content. In the shown example, recorded types of content include a recommendation of a video (video), a recommendation of a game (game), friendship-making in a social media service (friending), input or a comment (comment), and an evaluation of content by another user (like).

The content item 1253 indicates information of actual content or a link to the actual content. The actual content is recorded when the content is formed of, for example, relatively short text, as in “a user (user_{—}0003) and a user (user_{—}0004) has become friends” in friendship-making (friending) content. The link to the actual content is recorded when the content is formed of a relatively large volume of data, as in video recommendation (video) content.

The time stamp item 1156 indicates the time at which content is registered. For example, the time at which content is registered may be used in the collaborative filtering or the CBF executed by the score calculating unit 130 or may be used simply for managing the content data.

FIG. 7 illustrates an example of a content-relationship-indicating score according to an embodiment of the present disclosure. Referring to FIG. 7, a first content-relationship-indicating score 1350 stored in the score DB 135 includes a from-content-ID item 1351, a to-content-ID item 1352, and a score item 1353.

Two target pieces of content are identified based on the from-content-ID item 1351 and the to-content-ID item 1352. The score item 1353 indicates, for example, a relationship-indicating score calculated for these pieces of content by the score calculating unit 130 based on the collaborative filter and the CBF as described above.

In the example of the score calculation described above, the score calculating unit 130 may execute both the collaborative filter and the CBF or may execute one of the two. Alternatively, the score calculating unit 130 may execute filtering that is different from the collaborative filter or the CBF.

### 5. Calculation or Preference-Indicating Score

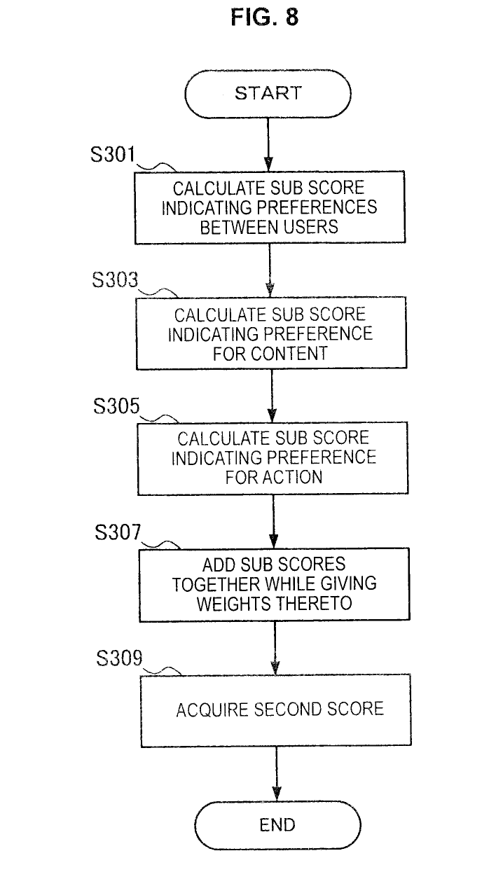

FIG. 8 is a flowchart illustrating an example of a process for calculating a preference-indicating score in accordance with an embodiment of the present disclosure. Referring to FIG. 8, the score calculating unit 130 first calculates a first sub score indicating preferences between users based on user's action log stored in the action DB 115 (S301). A specific method for calculating the first sub score will be described later.

After or concurrently with the above-described calculation of the first sub score, the score calculating unit 130 calculates a second sub score indicating user's preference for content (S303) and a third sub score indicating user's preference for an action (S305) based on user's action log stored in the action DB 115. The score calculating unit 130 adds the calculated first to third sub scores together while giving predetermined weights thereto (S307) so as to acquire a second score indicating user's preference for content (S309).

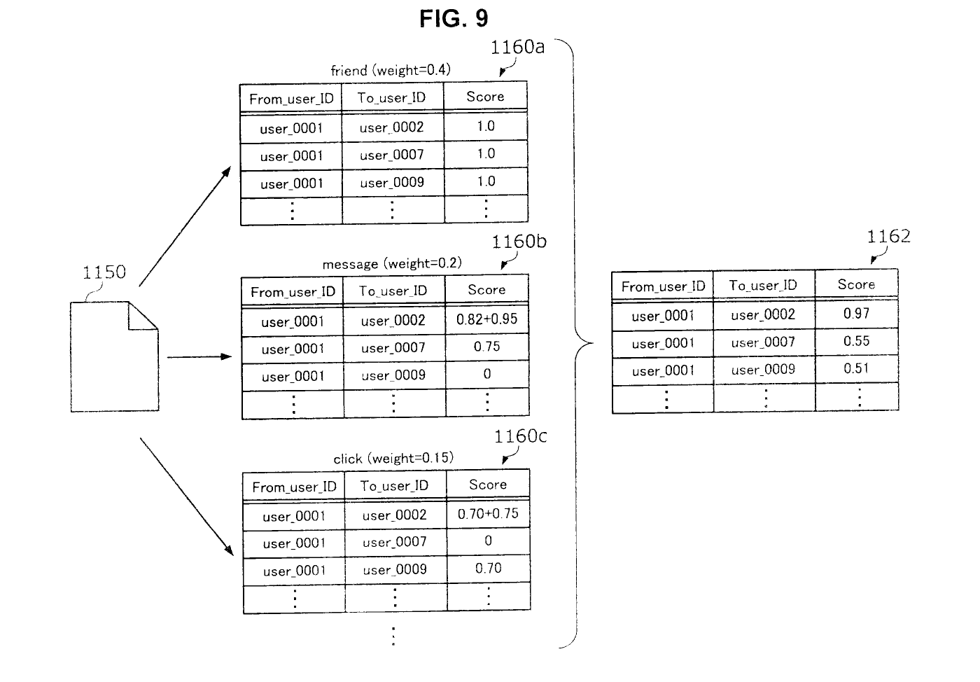

FIG. 9 illustrates an example of how a sub score (i.e., the first sub score) indicating preferences between users is calculated in accordance with an embodiment of the present disclosure. Referring to FIG. 9, based on user's action log 1150, a sub score table 1160 is generated for each action type. The contents of the action log 1150 in the shown example may be the same as the action log 1150 described with reference to FIG. 4.

In the shown example, a friendship-making (friend) sub score table 1160a, a message-transmission (message) sub score table 1160b, and a clicking-on-relevant-content (click) sub score table 1160c are generated. A score shown as addition (e.g. 0.82+0.95) in each sub score table 1160 indicates that scores based on a plurality of actions included in the action log 1150 have been added together. If the action log 1150 includes more action types, the sub score tables 1160 may include more tables generated in addition to the three in the shown example.

By adding together scores between users in these sub score tables 1160 while giving them weights set for the respective action types, a first sub score table 1162 is generated. In the shown example, weights of 0.4, 0.2, and 0.15 are set for the friendship-making (friend) action, the message transmission (message) action, and the clicking-on-relevant-content (click) action, respectively. Therefore, for example, a first sub score indicating preferences between a from-user (user_{—}0001) and a to-user (user_{—}0002) is acquired as follows: 1.0*0.4+(0.82+0.95)*0.2+(0.70+0.75)*0.15+0.97. As described above, if other sub score tables 1100 are additionally generated, the value of the first sub score may naturally vary.

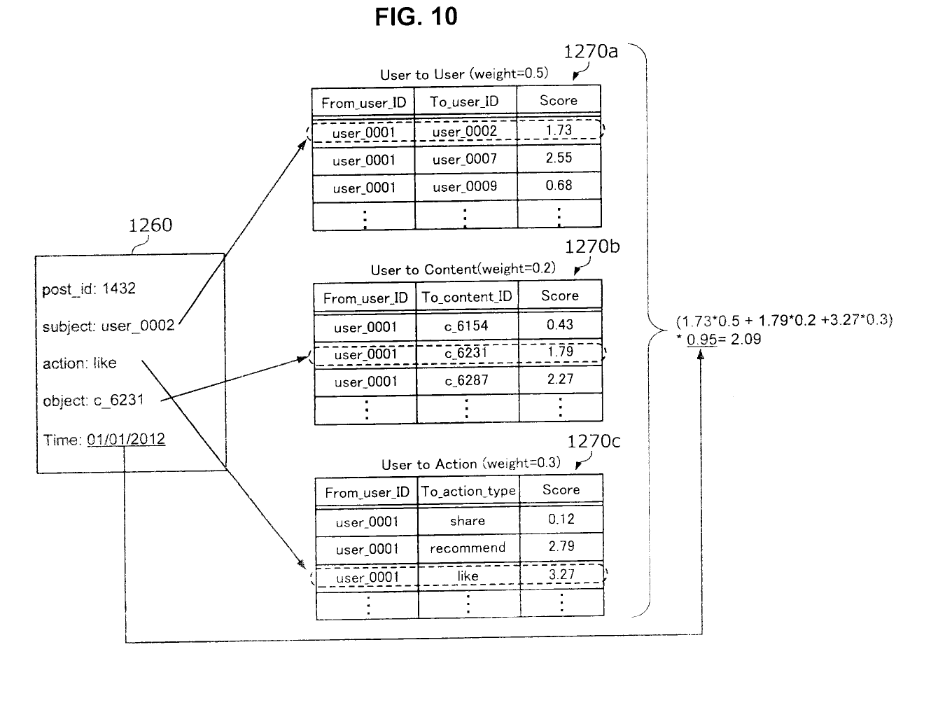

FIG. 10 illustrates an example of how a user-preference-indicating score is calculated in accordance with an embodiment of the present disclosure. Referring to FIG. 10, content 1260 has attributes including a subject user (user_{—}0002), an action type (an evaluation of content (like)), object content (content_{—}6231), and a time stamp (Jan. 1, 2012). In this case, the score calculating unit 130 generates a first sub score table 1270a indicating preferences between users, a second sub score table 1270h indicating user's preference for content, and a third sub score table 1270c indicating user's preference for an action.

For example, the first sub score table 1270a is generated similarly to the first sub score table 1162 described above with reference to FIG. 9. The second sub score table 1270h and the third sub score table 1270c may also be generated in a manlier similar to the first sub score table 1270a.

By adding together scores in these sub score tables 1270 while giving them weights set for the respective sub scores, a second score indicating users preference for content is calculated. In the shown example, weights of 0.5, 0.2, and 0.3 are set for a first sub score (table 1270a), a second sub score (table 1270b), and a third sub score (table 1270c), respectively. Therefore, with regard to the content 1260, these sub scores are added together as follows: 1.73*0.5+1.79*0.2+3.27*0.3=2.20.

Furthermore, in the shown example, the score is corrected by using the time stamp such that the score becomes higher for new content. More specifically, since the time stamp (Jan. 1, 2012) of the content 1260 indicates that the content 1260 is not very new at the point when the score is calculated, the score is multiplied by a coefficient of 0.95 based on this fact, so that the second score that is ultimately calculated becomes 2.09=2.20*0.95.

### 6. Generation of Layout Information

FIG. 11 is a flowchart illustrating an example of a layout-information generating process at the start of display of the information field, in accordance with an embodiment of the present disclosure. Referring to FIG. 11, when the layout-information generating unit 150 receives a request from the terminal device 200 (S401), the layout-information generating unit 150 acquires user's action log of the terminal device 200 from the action DB 115 (S403). In this case, the layout-information generating unit 150 may limit the action log to be acquired to, for example, an action log added in a most recent predetermined period.

Furthermore, the layout-information generating unit 150 acquires a first score indicating the relationship between content acquired by the content acquisition unit 120 or content stored in the content DB 125 and content appearing in the action log (S405). In this case, the layout-information generating unit 150 may read the first score stored in the score DB 135 or may request the score calculating unit 130 for calculation of a new score. Moreover, the layout-information generating unit 150 aggregates the acquired first score for each piece of content acquired by the content acquisition unit 120 or each piece of content stored in the content DB 125 (S407).

Subsequently, the layout-information generating unit 150 identities N pieces of content with upper-ranked aggregated scores (N being a predetermined number) as content constituting the information field (S409), and generates layout information for arranging these pieces of content and displaying the information field (S411). In other words, in the shown example, the pieces of content extracted as the content constituting the information field are pieces of content that are highly related to content targeted for a certain type of an action by the user.

As an additional configuration, with regard to the pieces of content identified as the content constituting the information field, the layout-information generating unit 150 may include the metadata of each piece of content and the first score indicating the relationship between the pieces of content into the layout information (S413). The metadata and the first score may be included in the content data.

As another example, when the layout-information generating unit 150 receives a request from the terminal device 200, the layout-information generating unit 150 may acquire a second score indicating user's preference for each piece of content with regard to the content acquired by the content acquisition unit 120 or the content stored in the content DB 125 and identify N pieces of content with upper-ranked second scores (N being a predetermined number) as the content constituting the information field.

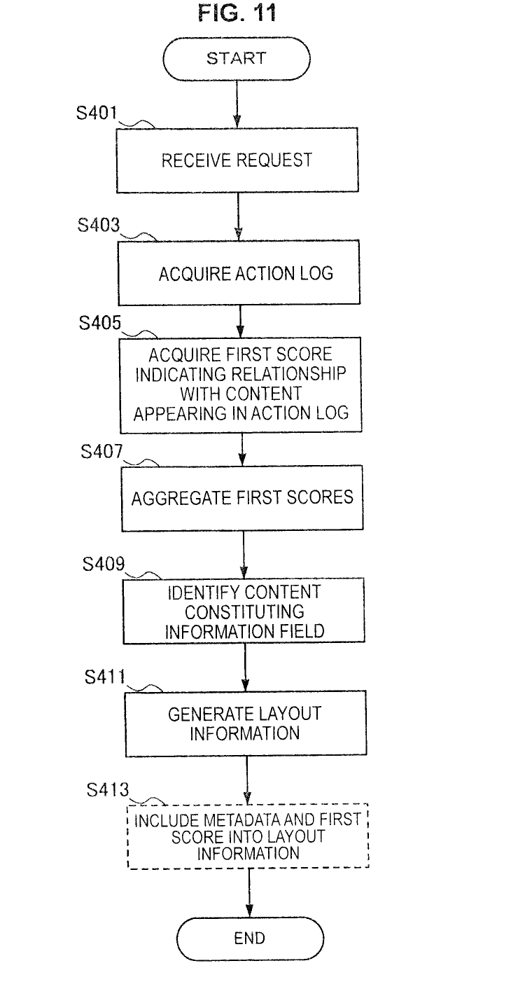

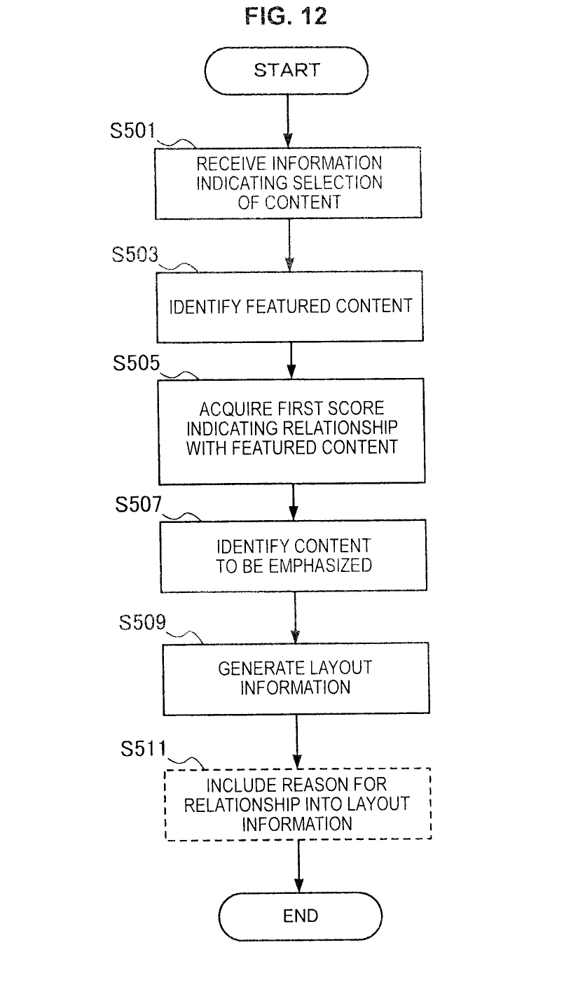

FIG. 12 is a flowchart illustrating an example of the layout-information generating process when the information field in being displayed, in accordance with an embodiment of the present disclosure. Referring to FIG. 12, when the featured-content identifying unit 140 receives, from the terminal device 200, information indicating that any one of the pieces of content displayed as the information field has been selected by the user (S501), the featured-content identifying unit 140 identities the selected content as user's featured content (S503).

Subsequently, the layout-information generating unit 150 acquires a first score indicating the relationship between the featured content and another piece of content included in the information field (S505). If step S413 is executed in the example shown in FIG. 11, the first score that is necessary here is already included in the content data or layout information. The layout-information generating unit 150 identifies content with the acquired first score larger than or equal to a predetermined threshold value or N upper-ranked pieces of content (N being a predetermined number) as content to be emphasized (S507). The layout-information generating unit 150 generates layout information such that these pieces of content are emphasized (S509).

As an additional configuration, the layout-information generating unit 150 may refer to sub scores stored together with the first score in the score DB 135 so as to identify the reason for the relationship between pieces of content (S509), and include the information indicating the reason for the relationship between pieces of content into the layout information (S511). The information indicating the reason for the relationship may alternatively be included in the content data. Examples of the reason for the relationship include “a comment related to the same content”, “pieces of content of the same genre”, and “pieces of content evaluated by the same person”.

In the above-described example of the generation of layout information, the content selection made by the user may be determined based on, for example, clicking on content or a mouse-over performed thereon using a mouse, tapping on content using a touchscreen, and gazing at content detected using visual recognition. If step S413 is executed in the above-described example shown in FIG. 11, since necessary information is included in the content data or the layout information, the process shown in FIG. 12 may be executed by the display controller of the terminal device 200 instead of the server 100.

### 7. Emphasized Display

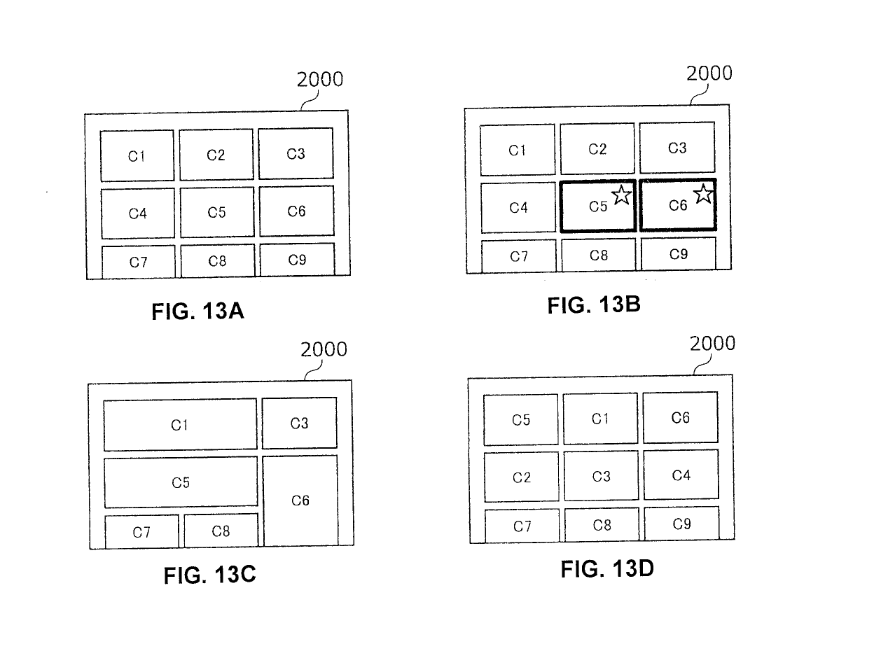

FIGS. 13A to 13D illustrate a first example of emphasized content display according to an embodiment of the present disclosure. FIG. 13A illustrates display of an information field 2000 in a normal state. The information field 2000 includes content C1 to content C9. Because the information field 2000 is displayed on, for example, a relatively-large-size display equipped in a terminal device, such as a tablet terminal or a personal computer, the pieces of content are arranged in the form of tiles in the vertical and horizontal directions. In the normal state, the content C1 to the content C9 are arranged with substantially identical sizes. Although not shown, the information field 2000 may be capable of displaying more pieces of content other than the content C1 to the content C9 by, for example, scrolling downward.

FIG. 13B illustrates a first example of display of the information field 2000 when the content C5 is identified as featured content. In this case, in the information field 2000, the content C5, which is the featured content, and the content C6, which is highly related to the content C5, are each displayed with a content frame having a color different from that of other content and also with an icon (star). Accordingly, emphasized display of content related to the featured content may be realized by changing the display style of the content.

FIG. 13C illustrates a second example of display of the information field 2000 when the content C5 is identified as featured content. In this case, in the information field 2000, the content C5, which is the featured content, and the content C1 and the content C6, which are highly related to the content C5, are each displayed in a region larger than that of other content. On the other hand, the display regions of the content C2, the content C4, and the content C9 that are lowly related to the content C5 disappear, and these pieces of content are not included in the information field 2000 at least temporarily. Accordingly, emphasized display of content related to the featured content may be realized by enlarging the display region of the content.

FIG. 13D illustrates a third example of display of the information field 2000 when the content C5 is identified as featured content. In this case, in the information field 2000, the displayed order of content are changed such that the content C5, which is the featured content, is displayed first and the content C1 and the content C6, which are highly related to the content C5, are displayed next. Accordingly, emphasized display of content related to the featured content may be realized by changing the displayed order of content.

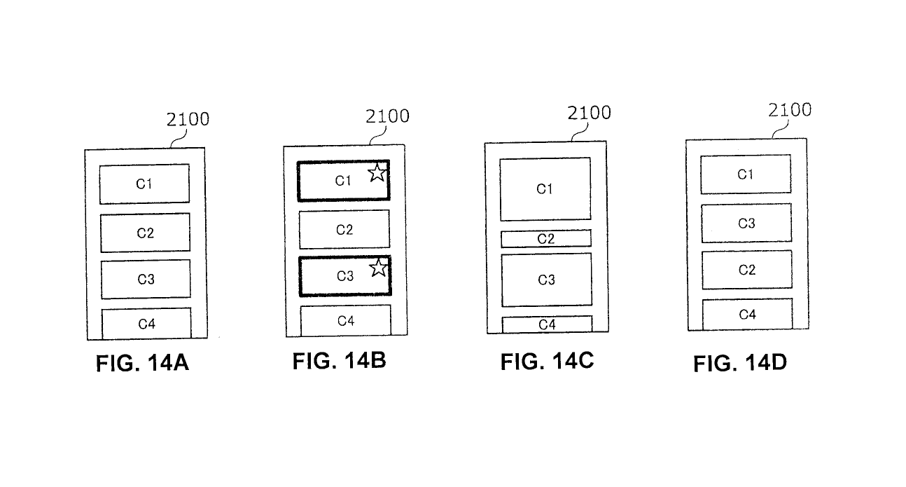

FIGS. 14A to 14D illustrate a second example of emphasized content display according to an embodiment of the present disclosure. FIG. 14A illustrates display of an information field 2100 in a normal state. The information field 2100 includes content C1 to content C4. Because the information field 2100 is displayed on, for example, a relatively-small-size display equipped in a terminal device such as a smartphone, the pieces of content are arranged in a single line in the vertical direction (or the horizontal direction). In the normal state, the content C1 to the content C4 are arranged with substantially identical sizes. Although not shown, the information field 2100 may be capable of displaying more pieces of content other than the content C1 to the content C4 by, for example, scrolling downward.

FIG. 14B illustrates a first example of display of the information field 2100 when the content C3 is identified as featured content. In this case, in the information field 2100, the content C3, which is the featured content, and the content C1, which is highly related to the content C3, are each displayed with a content frame having a color different from that of other content and also with an icon (star). Accordingly, in the information field 2100, emphasized display of content related to the featured content may be realized by changing the display style of the content.

FIG. 14C illustrates a second example of display of the information field 2100 when the content C3 is identified as featured content. In this case, in the information field 2100, the content C3, which is the featured content, and the content C1, which is highly related to the content C3, are each displayed in a region larger than that of other content. On the other hand, the display regions of the content C2 and the content C4 that are lowly related to the content C3 are reduced in size. Accordingly, in the information field 2100, emphasized display of content related to the featured content may be realized by enlarging the display region of the content.

FIG. 14D illustrates a third example of display of the information field 2100 when the content C3 is identified as featured content. In this case, in the information field 2100, the displayed order of content are changed such that the content C3, which is the featured content, and the content C1, which is highly related to the content C3, are displayed at higher ranks than other content. Accordingly, in the information field 2100, emphasized display of content related to the featured content may be realized by changing the displayed order of content.

### 8. Hardware Configuration

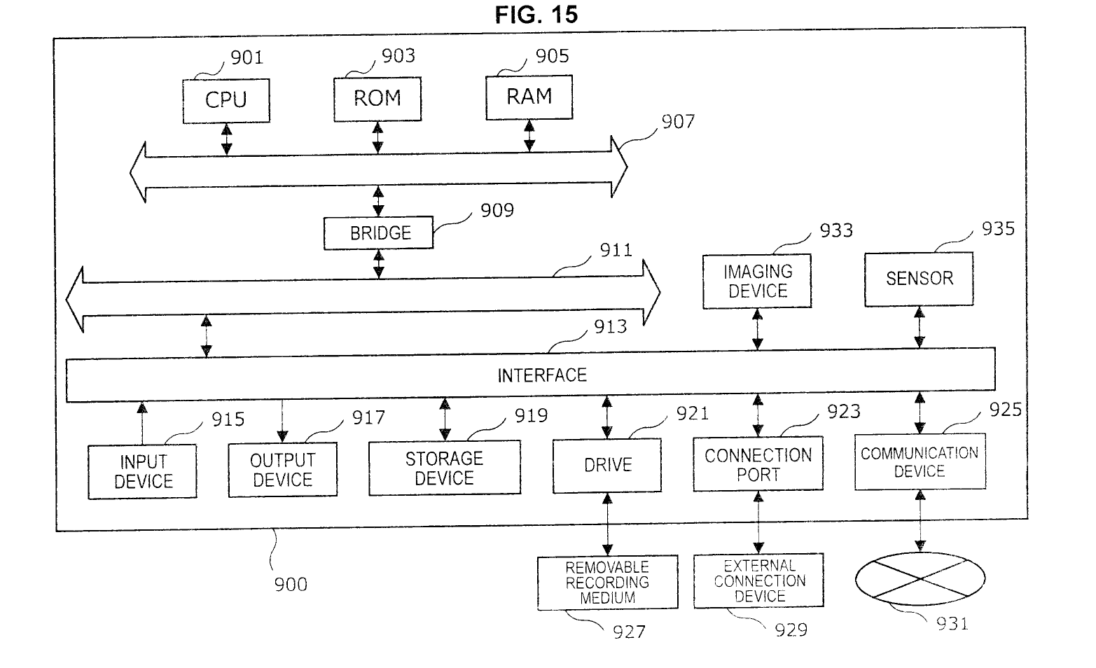

Next, a hardware configuration of an information processing device according to an embodiment of the present disclosure will be described with reference to FIG. 15. FIG. 15 is a block diagram illustrating a hardware configuration example of the information processing device according to the embodiment of the present disclosure. An information processing device 900 shown in FIG. 15 may realize, tot example, the server device or the terminal device in the above-described embodiment.

The information processing device 900 includes a central processing unit (CPU) 901, a read-only memory (ROM) 903, and a random access memory (RAM) 905. The information processing device 900 may also include a host bus 907, a bridge 909, an external bus 911, an interface 913, an input device 915, an output device 917, a storage device 919, a drive 921, a connection port 923, and a communication device 925. Furthermore, where appropriate, the information processing device 900 may include an imaging device 933 and a sensor 935. The information processing device 900 may have a processing circuit, such as a so-called digital signal processor (DSP) or a so-called application specific integrated circuit (ASIC), in place of or in addition to the CPU 901.

The CPU 901 functions as an arithmetic processor and a controller and controls the overall operation or a part thereof within the information processing device 900 in accordance with various kinds or programs recorded in the ROM 903, the RAM 905, the storage device 919, or a removable recording medium 927. The ROM 903 stores, for example, arithmetic parameters and programs to be used by the CPU 901. The RAM 905 temporarily stores, for example, a program executed by the CPU 901 as well as parameters that appropriately change during the execution of the program. The CPU 901, the ROM 903, and the RAM 905 are connected to each other via the host bus 907, which is constituted of an internal bus such as a CPU bus. Furthermore, the host bus 907 is connected to the external bus 911, such as a peripheral component interconnect/interface (PCI), via the bridge 909.

The input device 915 is a user-operable device, such as a mouse, a keyboard, a touchscreen, a button, a switch, and a lever. The input device 915 may be, for example, a remote control device that uses infrared or other electric waves, or an external connection device 929 such as a portable telephone that complies with operation of the information processing device 900. The input device 915 includes an input control circuit that generates an input signal based on information input by the user and that outputs the input signal to the CPU 901. The user may operate this input device 915 so as to input various kinds of data to the information processing device 900 or to command the information processing device 900 to perform processing.

The output device 917 is constituted by a device that is capable of visually or aurally notifying the user of acquired information. The output device 917 may be, for example, a display device, such as a liquid crystal display (LCD), a plasma display panel (PDP), or an organic electroluminescence (EL) display, an audio output device, such as a speaker and a headphone, and a printer. The Output device 917 outputs an obtained result of processing performed by the information processing device 900 in the form of text or an image and also in the form of voice or sound.

The storage device 919 is a data storage device formed as an example of a storage unit of the information processing device 900. The storage device 919 is constituted of for example, a magnetic storage device, such as a hard disk drive (HDD), a semiconductor storage device, an optical storage device, or a magneto-optical storage device. This storage device 919 stores, for example, various kinds of data and programs executed by the CPU 901, as well as various kinds of data acquired from an external source.

The drive 921 is a reader-writer for the removable recording medium 927, such as a magnetic disk, an optical disk, a magneto-optical disk, or a semiconductor memory, and is built inside or externally connected to the information processing device 900. The drive 921 reads information recorded in the mounted removable recording medium 927 and outputs the information to the RAM 905. Furthermore, the drive 921 records and writes information into the mounted removable recording, medium 927.

The connection port 923 is a port used for directly connecting a device to the information processing device 900. The connection port 923 may be, for example, a universal serial bus (USB) port, an IEEE1394 port, or a small computer system interface (SCSI) port. Alternatively, the connection port 923 may be, for example, an RS-232C port, an optical audio terminal, or a high-definition multimedia interlace (HDMI (registered trademark)) port. By connecting the external connection device 929 to the connection port 923, various kinds of data are exchangeable between the information processing device 900 and the external connection device 929.

The communication device 925 is, for example, a communication interface constituted of, for example, a communication device for connecting to a communication network 931. The communication device 925 may be, for example, a communication card for a wired or wireless local area network (LAN), Bluetooth (registered trademark), or a wireless USB (WUSB). Alternatively, the communication device 925 may be, for example, an optical communication router, an asymmetric digital subscriber line (ADSL) router, or various types of communication modems. For example, the communication device 925 exchanges a signal between the Internet and another communication device by using a predetermined protocol such as TCP/IP. The communication network 931 connected to the communication device 925 is a network connected in a wired or wireless manner and is, for example, the Internet, a domestic LAN, infrared communication, a radio-wave communication, or satellite communication.

The imaging device 933 is, for example, a device that generates a captured image by capturing real space by using various kinds of components including an imaging element, such as a charge coupled device (CCD) or a complementary metal oxide semiconductor (CMOS), and a lens for controlling formation of a subject image onto the imaging element. The imaging device 933 may be of a type that captures a still image or a type that captures moving images.

The sensor 935 is, for example, one of various types of sensors, such as an acceleration sensor, a gyro-sensor, a geomagnetic sensor, an optical sensor, or an audio sensor. The sensor 935 acquires, for example, information related to the state of the information processing device 900, such as the orientation of a housing of the information processing device 900, as well as information related to the environment surrounding the information processing device 900, such as the brightness or noise surrounding the information processing device 900. Furthermore, the sensor 935 may include a global positioning system (GPS) sensor that receives a GPS signal and measures the latitude, the longitude, and the altitude of a device.

An example of the hardware configuration of the information processing device 900 has been described above. Each of the components described above may be configured by using a general purpose component or may be configured by hardware specialized for the function of the component. The above configuration may be appropriately modified in accordance with the technological level at the time of implementation.

### 9. Supplement

The embodiments of the present disclosure may include, for example, the above-described information processing device (i.e. the server device or the terminal device), the above-described system, an information processing method executed by the information processing device or the system, a program for causing the information processing device to exhibits its function, and a non-transitory physical medium having the program stored therein.

Although the above description of the embodiments relates to an example in which a process such as generation of layout information is executed in the server, the embodiments of the present disclosure are not limited to such an example. For example, the functions of the content acquisition unit, the featured-content identifying unit, the layout-information generating unit, and/or the layout-information output unit described above may be realized similarly in the terminal device. Moreover, these functions may be realized by distributing them to the server aril the terminal device.

Although preferred embodiments of the present disclosure have been described in detail above with reference to the appended drawings, the technical scope of the embodiments of the present disclosure is not limited to the above example. It is obvious to those with a general knowledge of the technical field of the embodiments of the present disclosure that various modifications and alterations may occur within the technical scope defined in the claims, and that these modifications and alterations are encompassed within the technical scope of the embodiments of the present disclosure.

Furthermore, the advantages discussed in this specification are only intended for illustrative and exemplary purposes and are not limitative. In other words, in addition to or in place of the above-described advantages, the technology according to the embodiments of the present disclosure may exhibit other advantages that are obvious to a skilled person from the specification.

Additionally, the present technology may also be configured as below.

(1) An information processing device including:

a score calculating unit configured to calculate a score indicating a relationship between pieces of content;

a layout-information generating unit configured to extract content, which is highly related to content selected by a user from content displayed toward the user, based on the score and to generate layout information defining a layout in which the extracted content is emphasized; and

a layout-information output unit configured to output the layout information to a display controller for displaying the content toward the user.

(2) The information processing device according to (1),

wherein the layout-information generating unit extracts content that is highly related to content appearing in an action log of the user as the content displayed toward the user.

(3) The information processing device according to (1),

wherein the score calculating unit further calculates a score indicating a preference for content by the user based on an action log of the user, and

wherein the layout-information generating unit extracts content with a high preference as the content displayed toward the user.

(4) The information processing device according to (3),

wherein the score calculating unit calculates the score indicating the preference based on another user, content, or an action type appearing in the action log.

(5) The information processing device according to any one of (1) to (4),

wherein the score calculating unit calculates the score by executing filtering using an action log of the user.

(6) The information processing device according to (5),

wherein the score calculating unit calculates the score by executing collaborative filtering using the action log of the user.

(7) The information processing device according to any one of (1) to (6),

wherein the score calculating unit calculates the score by executing filtering using metadata of the content.

(8) The information processing device according to (7),

wherein the score calculating unit calculates the score by executing content-based filtering using the metadata of the content.

(9) The information processing device according to any one of (1) to (8),

wherein the extracted content is emphasized by changing a display style.

(10) The information processing device according to any one of (1) to (9),

wherein the extracted content is emphasized by changing a display order.

(11) The information processing device according to any one of (1) to (10),

wherein the extracted content is emphasized by enlarging a display region.

(12) the information processing device according to (1), further including:

the display controller.

(13) An information processing method including:

calculating a score indicating a relationship between pieces of content;

causing a processor to extract content, which is highly related to content selected by a user from content displayed toward the user, based on the score and to generate layout information defining a layout in which the extracted content is emphasized; and

outputting the layout information to a display controller for displaying the content toward the user.

(14) A program causing a computer to exhibit:

a function that calculates a score indicating a relationship between pieces of content;

a function that extracts content, which is highly related to content selected by a user from content displayed toward the user, based on the score and that generates layout information defining a layout in which the extracted content emphasized; and

a function that outputs the layout information to a display controller for displaying the content toward the user.

What is claimed is:

1. An information processing device comprising:
a score calculating unit configured to calculate a score indicating a relationship between pieces of content;
a layout-information generating unit configured to extract content, which is highly related to content selected by a user from content displayed toward the user, based on the score and to generate layout information defining a layout in which the extracted content is emphasized; and
a layout-information output unit configured to output the layout information to a display controller for displaying the content toward the user.

2. The information processing device according to claim 1,
wherein the layout-information generating unit extracts content that is highly related to content appearing in an action log of the user as the content displayed toward the user.

3. The information processing device according to claim 1,
wherein the score calculating unit further calculates a score indicating a preference for content by the user based on an action log of the user, and
wherein the layout-information generating unit extracts content with a high preference as the content displayed toward the user.

4. The information processing device according to claim 3,
wherein the score calculating unit calculates the score indicating the preference based on another user, content, or all action type appearing in the action log.

5. The information processing device according to claim 1,
wherein the score calculating unit calculates the score by executing tittering using an action log of the user.

6. The information processing device according to claim 5,
wherein the score calculating unit calculates the score by executing collaborative filtering using the action log of the user.

7. The information processing device according to claim 1,
wherein the score calculating unit calculates the score by executing filtering using metadata of the content.

8. The information processing device according to claim 7,
wherein the score calculating unit calculates the score by executing content-based filtering using the metadata of the content.

9. The information processing device according to claim 1,
wherein the extracted content is emphasized by changing a display style.

10. The information processing device according to claim 1,
wherein the extracted content is emphasized by changing a display order.

11. The information processing device according to claim 1,
wherein the extracted content is emphasized by enlarging a display region.

12. The information processing device according to claim 1, further comprising:
the display controller.

13. An information processing method comprising:
calculating a score indicating a relationship between pieces of content;
causing a processor to extract content, which is highly related to content selected by a user from content displayed toward the user, based on the score and to generate layout information defining a layout in which the extracted content is emphasized; and
outputting the layout information to a display controller for displaying the content toward the user.

14. A program causing a computer to exhibit:
a function that calculates a score indicating a relationship between pieces of content;
a function that extracts content, which is highly related to content selected by a user from content displayed toward the user, based on the score and that generates layout information defining a layout in which the extracted content is emphasized; and
a function that outputs the layout information to a display controller for displaying the content toward the user.
